(19) United States
(12) Patent Application Publication
(10) Pub. No.: US 2008/0108484 A1
(43) Pub. Date: May 8, 2008

(54) Multi-functionsl massage body-building device

(76) Inventors: Chun-Hsien Wu, Taipei Hsien (TW); Yan Hsu, Taipei Hsien (TW); Wei-Chen Wang, Taipei Hsien (TW)

Correspondence Address: CHUN-HSIEN WU, Box 8-24, 235 Chung-Ho, Taipei, omitted

(21) Appl. No.: 11/593,941

(22) Filed: Nov. 8, 2006

(51) Int. Cl. A63B 21/02; A61H 15/00

(52) U.S. Cl. 482/122; 601/118; 601/33

(57) ABSTRACT

A massage body-building device comprises a rod body; the rod body integrally formed with at least one massage body; the massage body having a plurality of noses; two ends of the rod body being formed with respective stops; each of two surfaces near two ends of the rod body being formed with a through hole and two embedding holes; two rollers engaged to the portions of the rod body near two ends of the rod body; two positioning sleeves installed at two ends of the rod body; each positioning sleeve having a through hole; two plugs for sealing the two positioning sleeves; and an elastic rope having two ends which are installed to the rod body. Each of two end surfaces of the rod body is formed with a projection; one end of each positioning sleeve has an inner annular ring; and one edge of the ring has a recess for receiving the projection of the rod body.

### FIELD OF THE INVENTION

The present invention relates to a massage body-building device, and particularly to a multi-functional massage body-building device which can be carried conveniently.

### BACKGROUND OF THE INVENTION

There are various kinds of massage devices and body-building devices. Current each device has only one function and thus people must buy various body building devices for suiting various applications. Moreover, after exercise, users must further buy massage device for massaging the body to releasing aches of the body. Thus users must take more money to buy these devices and a great space is necessary for storing these devices. Furthermore generally, the massage and body-building devices are inconvenient in carrying out and thus they are confined to be used in some places.

### SUMMARY OF THE INVENTION

Accordingly, the primary object of the present invention is to provide a multi-functional massage body-building device which can be carried and stored conveniently and the devices has many applications so that it can replace many prior art massage and body-building device.

To achieve above objects, the present invention provides a massage body-building device which comprises a rod body; the rod body integrally formed with at least one massage body; the massage body having a plurality of noses; two ends of the rod body being formed with respective stops; each of two surfaces near two ends of the rod body being formed with a through hole and two embedding holes; two rollers engaged to the portions of the rod body near two ends of the rod body; two positioning sleeves installed at two ends of the rod body; each positioning sleeve having a through hole; two plugs for sealing the two positioning sleeves; and an elastic rope having two ends which are installed to the rod body. Each of two end surfaces of the rod body is formed with a projection; one end of each positioning sleeve has an inner annular ring; and one edge of the ring has a recess for receiving the projection of the rod body.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is an assembled schematic view of the elastic rope of the present invention.

FIG. 3 is an assembled perspective view of the present invention.

FIG. 4 is an enlarged schematic view of the present invention.

FIG. 5 is an enlarged schematic view of the present invention, which is viewed from another orientation.

FIG. 6 shows the first application of the present invention.

FIG. 7 shows the second application of the present invention.

FIG. 8 shows the third application of the present invention.

FIG. 9 shows the fourth application of the present invention.

FIG. 10 shows the fifth application of the present invention.

FIG. 11 shows the sixth application of the present invention.

FIG. 12 shows the seventh application of the present invention.

FIG. 13 shows the eighth application of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

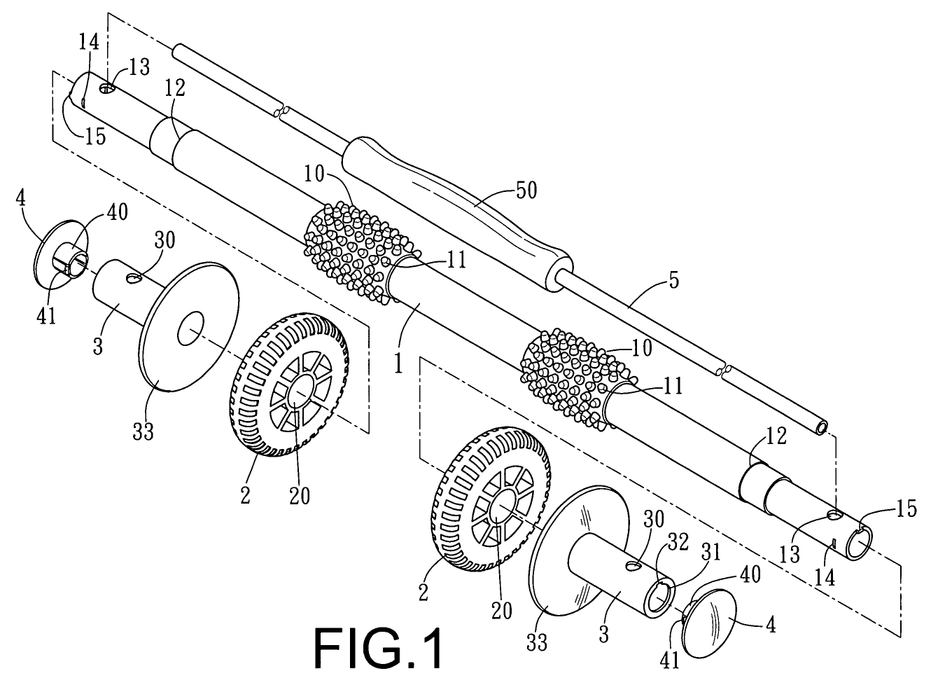

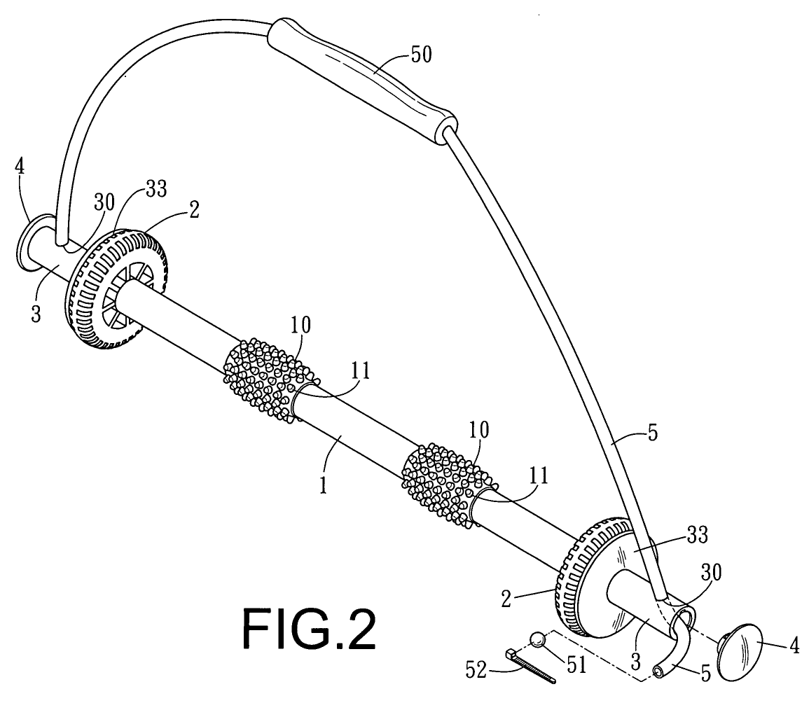

Referring to FIGS. 1 and 2, the structure of the present invention is illustrated. The present invention has the following elements.

A rod body 1 is a hollow tube. The rod body 1 is integrally formed with two massage bodies 10. Each massage body 10 has a plurality of noses 11. Two ends of the rod body 1 are formed with respective stops 12. Each of two surfaces near two ends of the rod body 1 is formed with a through hole 13 and two embedding holes 14. Each of two end surfaces of the rod body 1 is formed with a projection 15.

Two rollers 2 are engaged to the portions of the rod body 1 near two ends of the rod body 1, respectively. Each roller 2 has an axial hole 20.

Two positioning sleeves 3 are installed at two ends of the rod body 1. Each positioning sleeve 3 has a through hole 30. One end of the positioning sleeve 3 has an inner annular ring 31. One edge of the ring 31 has a recess 32. Another end of the positioning sleeve 3 has a stopper 33.

Two plugs 4 serve for sealing the two positioning sleeves 3 at the rings 31. One side of each plug 4 is a protrusion 40. Each protrusion 40 has two embedding bodies 41.

An elastic rope 5 has two ends which are installed to the rod body 1. The elastic rope 5 is installed with a soft handle 50. Each of two ends of the elastic rope 5 is installed with a positioning ball 51 and is sleeved by a strip 52.

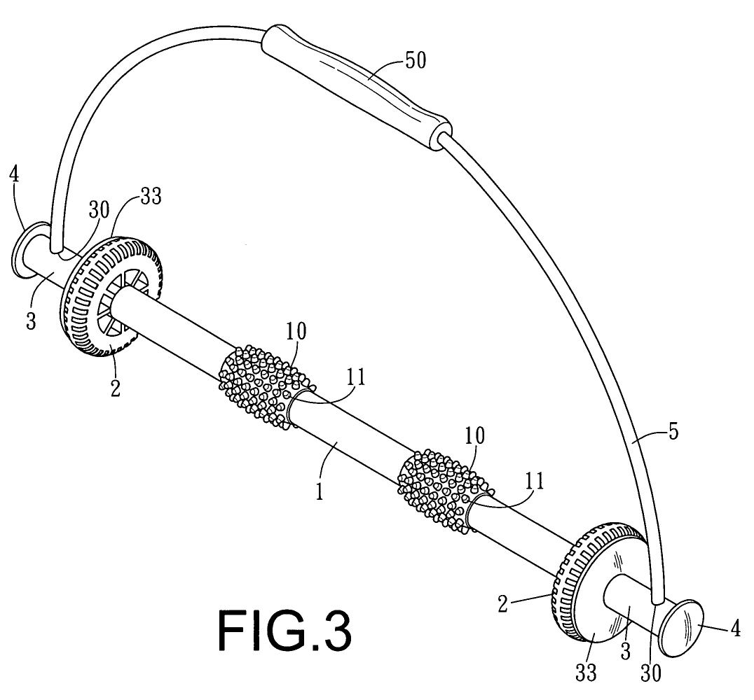

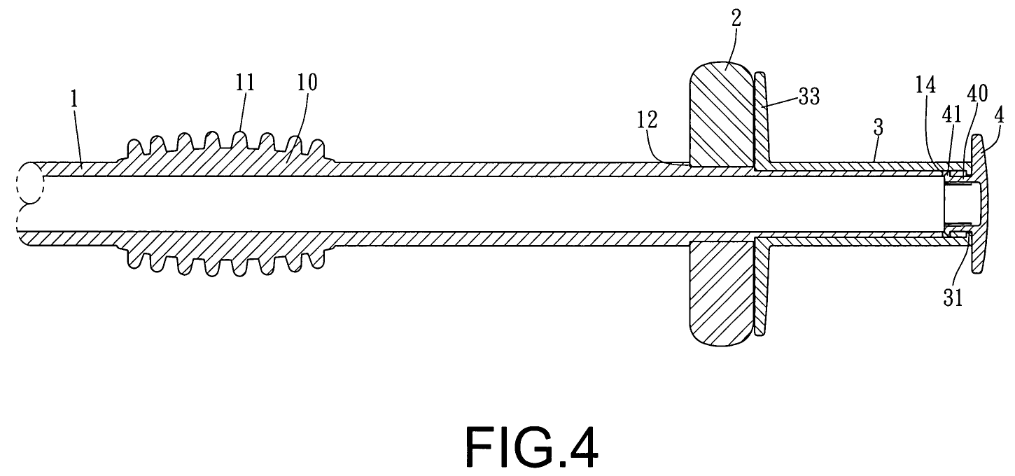

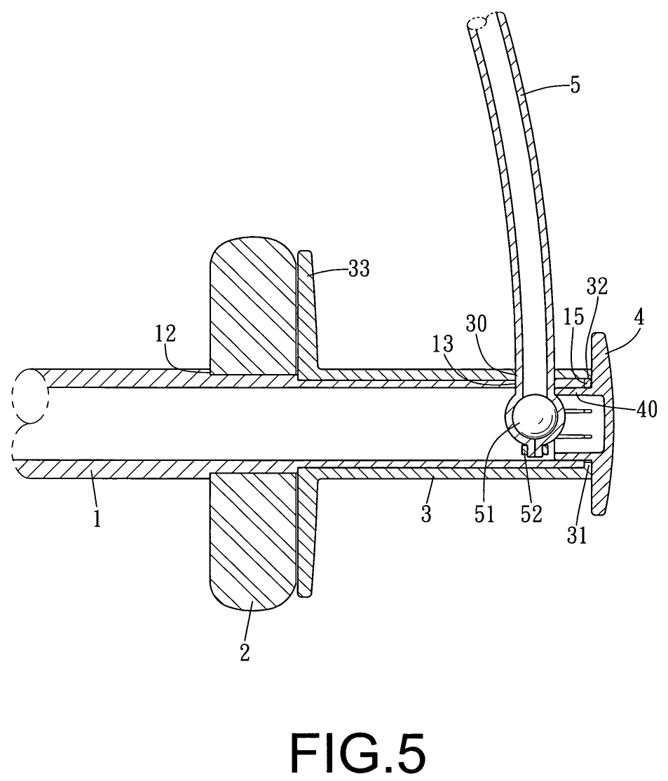

In assembly, referring to FIGS. 1 to 5, the two rollers 2 are installed to the two ends of the rod body 1. One side of each roller 2 resists against one of the two stops 12 so as to be positioned thereon. Then the positioning sleeves 3 are sleeved at two ends of the rod body 1 so that each roller 2 is between one stop 12 and one positioning sleeve 3. The projection 15 at one end surface of the rod body 1 is inserted into the recess 32 of the inner annular ring 31 of the positioning sleeve 3. The through hole 30 of the positioning sleeve 3 is aligned to the through hole 13 of the rod body 1. Another side of the roller 2 resists against another end surface of the positioning sleeve 3. The outer side of the roller 2 resists against the stopper 33 of the positioning sleeve 3. Then two ends of the elastic rope 5 are inserted into the through hole of the positioning sleeve 3 and the through hole 13 of the rod body 1. One end portion of the elastic rope 5 protrudes out from the end portion of the rod body 1 and the end portion of the elastic rope 5 is filled with the positioning ball 51. The ends of the elastic rope 5 are enclosed by the strips 52 so that the positioning balls 51 are limited within the elastic rope 5. Then the ends of the elastic rope 5 are inserted into the rod body 1 from the through hole 13 of the rod body 1. The positioning balls 51 have the effect of fixing the ends of the elastic rope 5. Then the plugs 4 cover two ends of the elastic rope 5. The protrusion 40 of the plug 4 is embedded into the embedding hole 14 of the elastic rope 5. Thus the sleeves 3 and the rollers 2 are positioned on the rod body 1. The assembly of the present invention is completed.

In use of the present invention, it is only necessary to drive the massage bodies 10 of the rod body 1 to contact the body of the user. The noses 11 of the massage bodies 10 will massage the skin of the body so as to achieve the effect of massage.

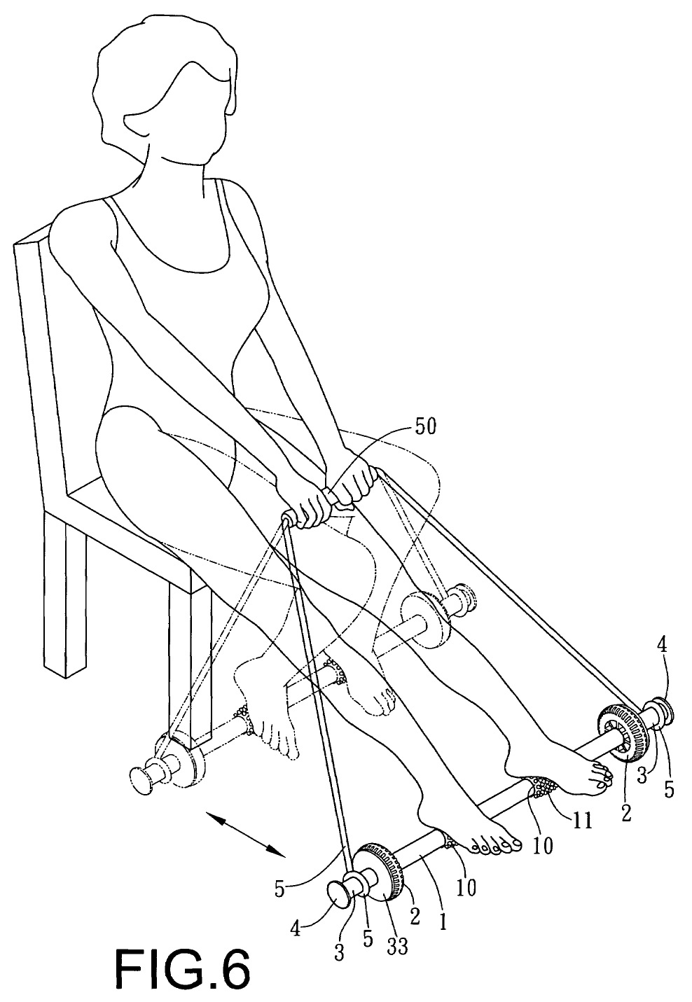

Referring to FIG. 6, when it is desired to massage the bottom of the leg, the user can sit and the legs of the user trades upon the massage bodies 10. The user's hand holes the handle 50 of the elastic rope 5 and legs of the user moves forwards and backwards so that the rollers 2 will roll. The noses 11 of the massage bodies 10 will massage the leg bottoms.

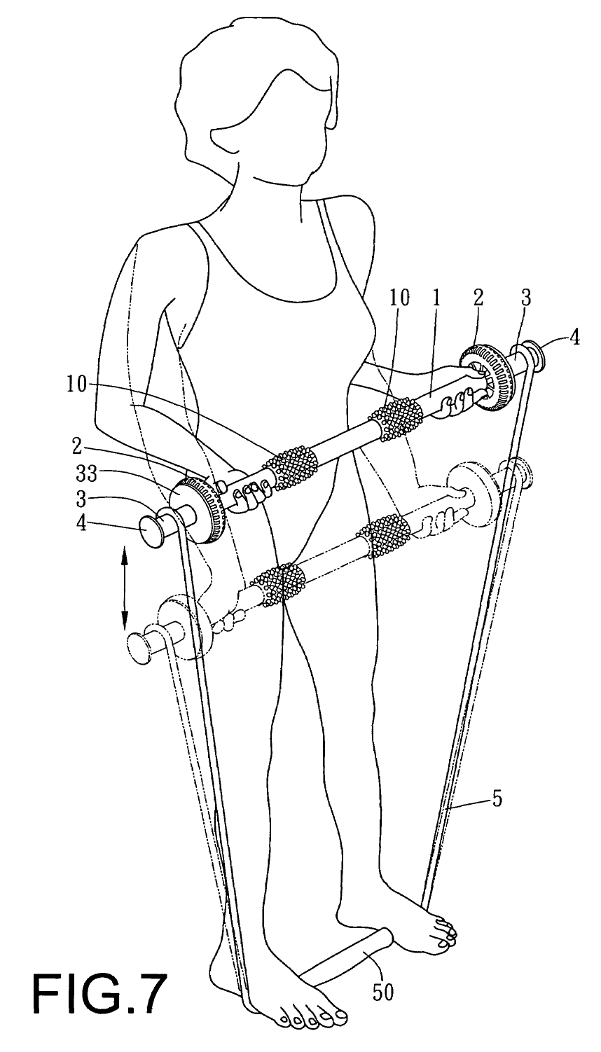

In using the present invention for body exercise, as referring to FIGS. 7 to 13, the user can have necessary poses to match the structure of the massage device of the present invention.

In one application, the user stands, two hands of the user hold the rod body 1 and two legs tread upon the elastic rope 5. The extension force of the elastic rope 5 will make the user can life and descend the rod body 1 repeatedly to train the arms, see FIG. 7.

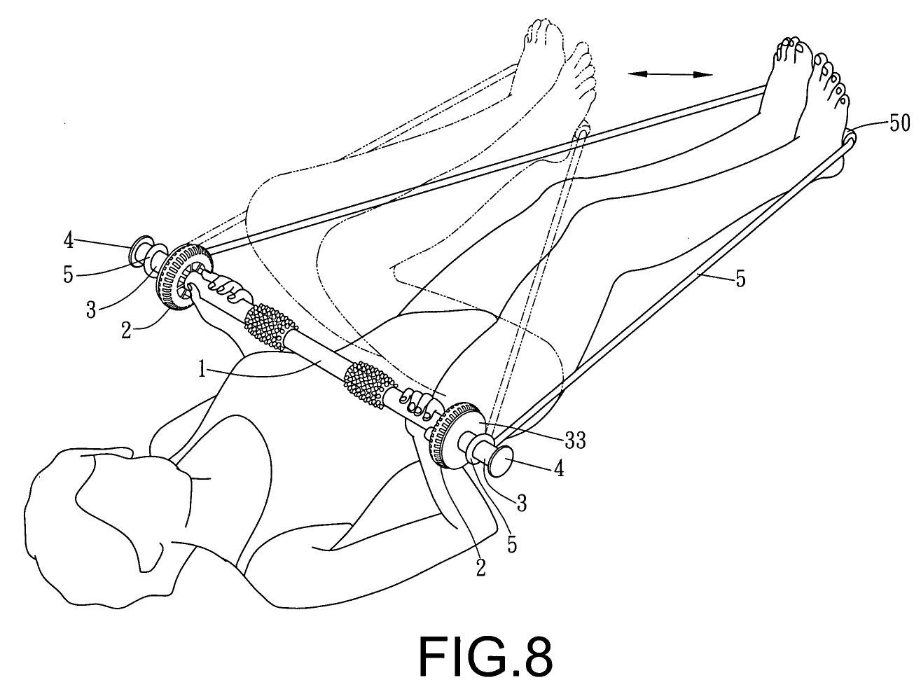

Referring to FIG. 8, in another application, the two hands hold the rod body 1 and two legs tread upon the handle 50 of the rope 5, the legs can bend and expand repeatedly to train the legs,

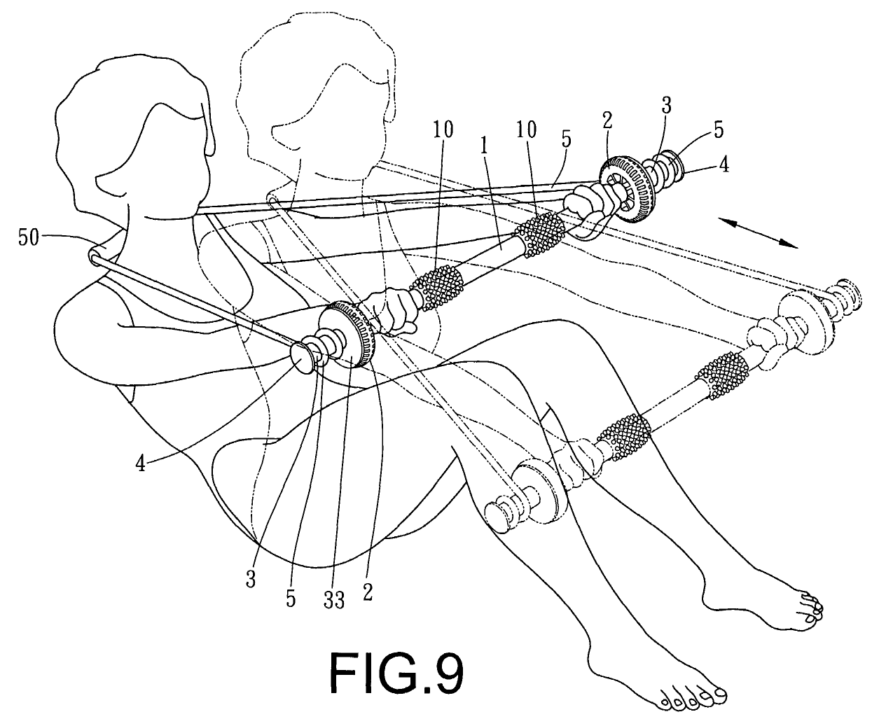

With reference to FIG. 9, in a further application, the two hands hold the rod body 1, the handle 50 of the rope 5 is placed upon the backside of the neck. The user can make sit-ups exercise for training abdomen.

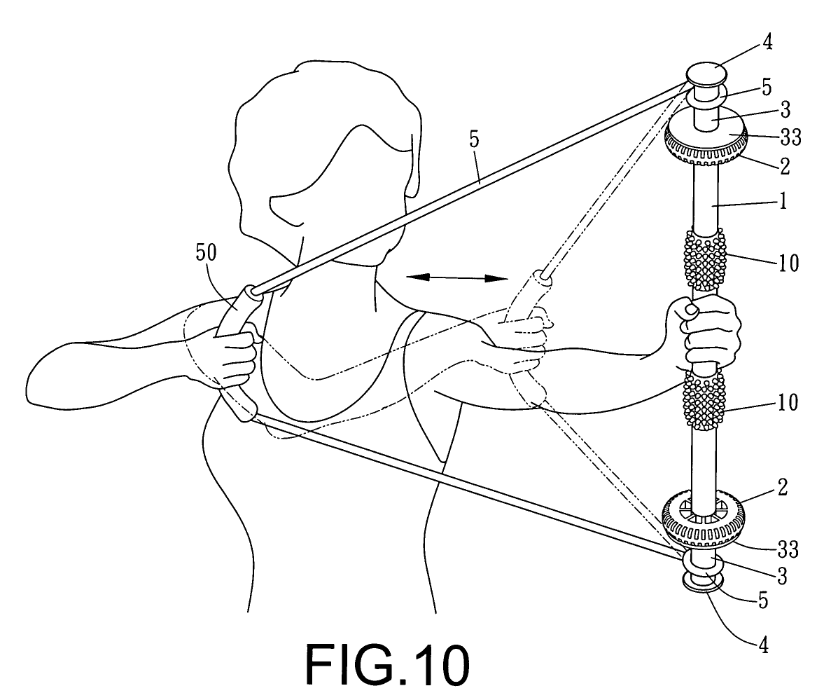

Referring to FIG. 10, the user holds the rod body 1 by one hand and hold the handle 50 by another hand and then extension the rope 5 for training the breast.

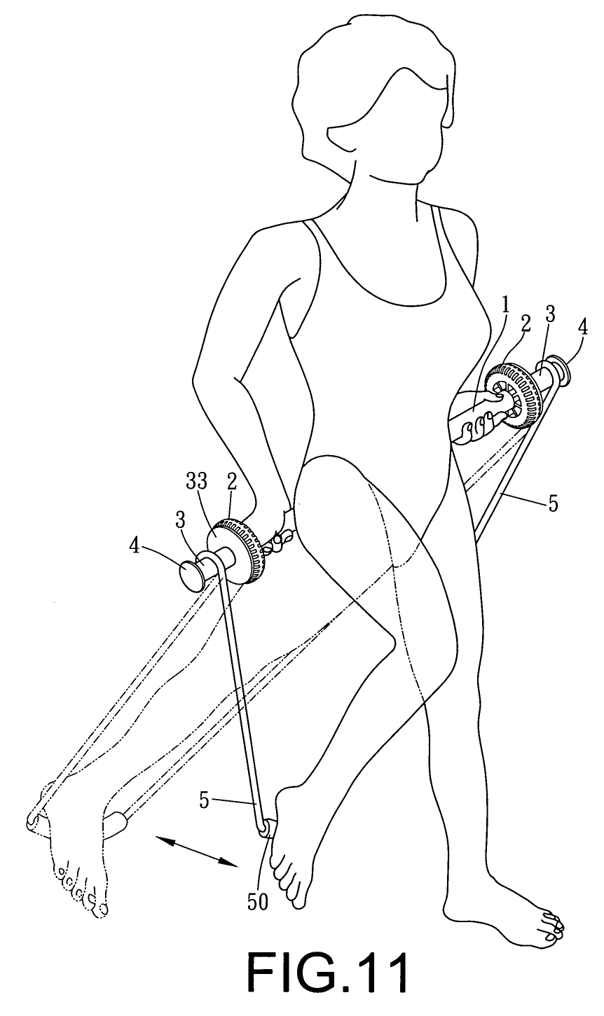

With reference to FIG. 11, the use holds the rod body 1 at two ends and the rod body 1 also attached to the back of the user and the leg tread the handle 50 of the rope 5. By lifting and descending the leg, the training the leg to reduce the undesired muscle of the leg.

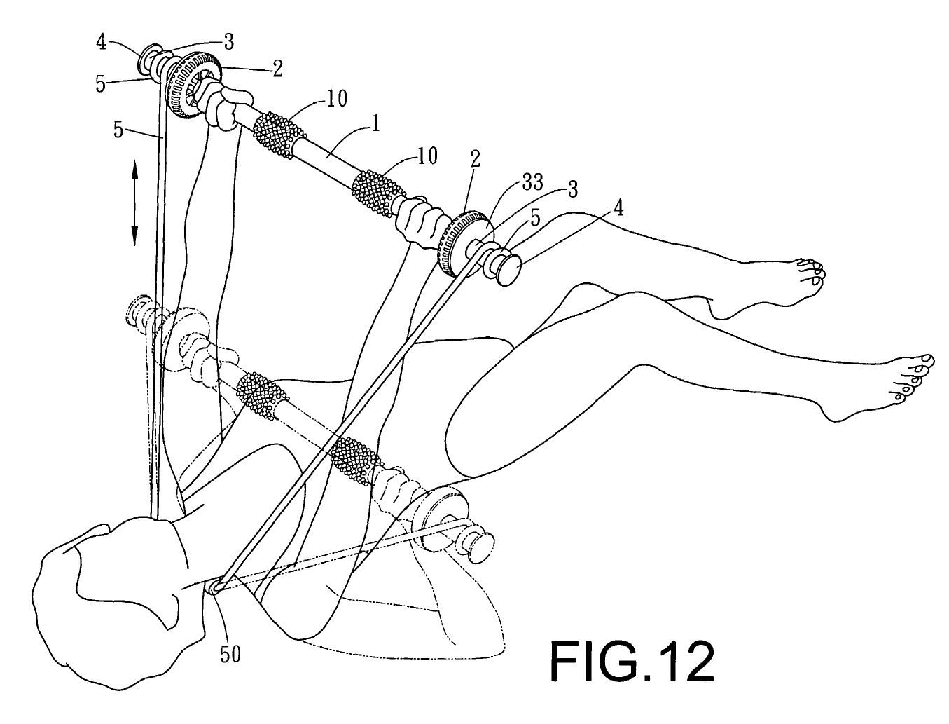

Referring to FIG. 12, the user lie upon the ground and hole the rod body 1 by two hands. The handle 50 of the rope 5 is placed upon the back of the neck. The user's hand moves upwards and downwards so as to train the hand.

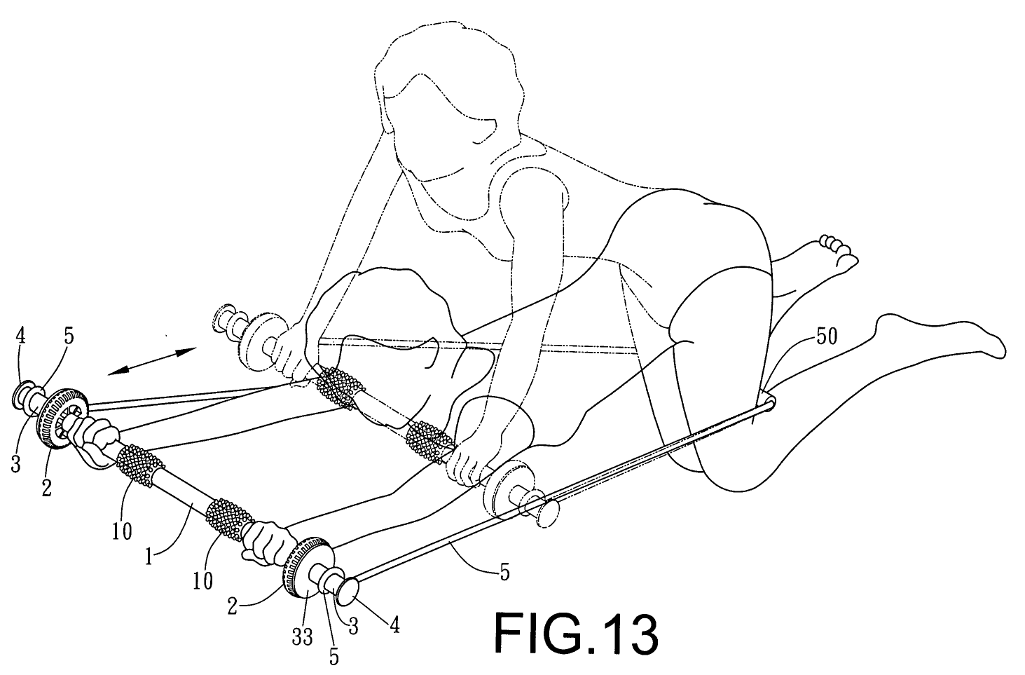

Referring to FIG. 13, the user knees on the ground, and the handle 50 of the rope 5 place on the backside of the joints of the legs, and the hands of the user hold the rod body 1, while the rollers 2 are placed upon the ground. The user moves the rollers 2 forwards and backwards repeatedly so as to train the abdomen and arms.

Furthermore in exercise, if the rope 5 is too long, the rope 5 can be wound around the positioning sleeves 3 at two ends of the rod body 1 until the user feels that the rope 5 is elastic. The stoppers 33 on the positioning sleeves 3 serve to prevent the rubbing action between the rope 5 and the rollers 2. Therefore, in the present invention, by using the rod body 1, rollers 2 and rope 5, the user can exercise by various application. The present invention has a compact size, and is light, and only occupies a small space. It can be carried conveniently. The user can use the device anywhere and anytime.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A massage body-building device comprising:
a rod body; the rod body integrally formed with at least one massage body ;the massage body having a plurality of noses; two ends of the rod body being formed with respective stops; each of two surfaces near two ends of the rod body being formed with a through hole and two embedding holes;
two rollers engaged to portions of the rod body near two ends of the rod body;
two positioning sleeves installed at two ends of the rod body; each positioning sleeve having a through hole;
two plugs for sealing the two positioning sleeves; and
an elastic rope having two ends which are installed to the rod body.

2. The massage body-building device as claimed in claim 1, wherein the rod body is a hollow tube.

3. The massage body-building device as claimed in claim 1, wherein each of two end surfaces of the rod body is formed with a projection; one end of each positioning sleeve has an inner annular ring; and one edge of the ring has a recess for receiving the projection of the rod body.

4. The massage body-building device as claimed in claim 1, wherein each of two surfaces near two ends of the rod body is formed with a through hole and two embedding holes; and one side of each plug has a protrusion; and each protrusion has two embedding bodies.

5. The massage body-building device as claimed in claim 1, wherein an outer side of the positioning sleeve has a stopper.

6. The massage body-building device as claimed in claim 1, wherein the elastic rope is installed with a soft handle; each of two ends of the elastic rope is installed with a positioning ball and is sleeved by a strip.
